(19) United States
(12) Patent Application Publication
(10) Pub. No.: US 2018/0210641 A1
(43) Pub. Date: Jul. 26, 2018

(54) METHOD AND ELECTRONIC DEVICE FOR MANAGING OPERATIONS AND FUNCTIONALITY OF APPLICATIONS

(71) Applicant: Samsung Electronics Co., Ltd., Suwon-si (KR)

(72) Inventors: Jith Thomas THELLEERATHU, Kerala (IN); Anil Kumar VAMANPALLY, Telangana (IN)

(21) Appl. No.: 15/879,838

(22) Filed: Jan. 25, 2018

(30) Foreign Application Priority Data
Jan. 25, 2017 (IN) 201741002857

(51) Int. Cl. G06F 3/0488; G06F 3/0481; G06F 3/0484; G06F 3/041; H04M 1/725

(52) U.S. Cl. CPC G06F 3/04883; G06F 3/04817; H04M 1/72522; G06F 3/0416; G06F 3/04842

(57) ABSTRACT

A method for managing operations of an electronic device and an apparatus therefor are provided. The method includes detecting an input performed on a first item associated with a first application and displayed on a display screen of the electronic device, wherein the first item is associated with at least one second item associated with at least one second application and performing at least one operation corresponding to the at least one second item associated with the at least one second application based on the input detected on the first item.

### CROSS-REFERENCE TO RELATED APPLICATION(S)

This application is based on and claims priority under 35 U.S.C. § 119 to Indian Patent Application No. 201741002857, filed on Jan. 25, 2017 in the Indian Intellectual Property Office, the disclosure of which is incorporated by reference herein in its entirety.

### TECHNICAL FIELD

The disclosure relates to electronic devices. More particularly, the disclosure relates to a method and an electronic device for managing of operations and functionalities of applications.

### BACKGROUND

Generally, an electronic device (e.g., a mobile device, a handheld device, a smart phone, or a tablet) includes a plethora of applications with one or more functionalities associated thereto. These applications can be pre-installed in the electronic device by the manufacturer or installed (i.e., third-party applications) by the user of the electronic device for serving the user's own interests.

Existing mechanism do not provide an association of one application functionality with any other third-party application(s). For example, a user of the electronic device cannot add customized actions or information to a particular screen, window or view of the third-party application(s). Thus, resulting in a limited user experience.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and electronic device for managing operations.

Another aspect of the disclosure is to provide a mechanism for detecting, by a functionality management unit, an input performed on a first item associated with a first application displayed on a display screen of the electronic device, wherein the first item is associated with at least one second item associated with at least one second application.

Another aspect of the disclosure is to provide a mechanism for performing, by the functionality management unit, at least one operation corresponding to the at least one second item associated with the at least one second application based on the first item.

Yet another aspect of the disclosure is to provide a mechanism for causing to display at least one second items associated with the at least one second application on the display screen of the electronic device.

Yet another aspect of the disclosure is to provide a mechanism for detecting an association event performed the at least one second item associated with the at least one second application displayed on the screen of the electronic device.

Yet another aspect of the disclosure is to provide a mechanism for detecting, by the functionality management unit, an input on the graphical element of the second application displayed on the display screen of the electronic device and causing to display at least one second item associated with at least one first application.

Another aspect of the disclosure is to provide a mechanism for dynamically associating the at least one second item associated with the at least one second application with the first item of the first application based on the association event.

Another aspect of the disclosure is to provide a mechanism for enhancing the functionalities of one or more applications.

In accordance with an aspect of the disclosure, a method for managing operations of an electronic device is provided. The method includes detecting, by a functionality management unit, an input performed on a first item associated with a first application displayed on a display screen of the electronic device, wherein the first item is associated with at least one second item associated with at least one second application. Further, the method includes performing, by the functionality management unit, at least one operation corresponding to the at least one second item associated with the at least one second application based on the first item.

In an embodiment of the disclosure, the first item is associated with the at least one second item associated with the at least one second application by detecting an input performed on the first item of a first application displayed on the display screen of the electronic device, causing to display at least one second items associated with the at least one second application on the display screen of the electronic device, detecting an association event performed on the at least one second item associated with the at least one second application displayed on the screen of the electronic device, and dynamically associating the at least one second item associated with the at least one second application with the first item of the first application based on the association event.

In an embodiment of the disclosure, the association is performed by creating a contextual relationship between the first item associated with the first application and the at least one second item associated with the at least one second application.

In an embodiment of the disclosure, the at least one second item is displayed in accordance to a priority associated with each of the second item.

In an embodiment of the disclosure, the at least one second item associated with the at least one second application to be displayed is dynamically determined based on at least one of applications frequently used with the first application, applications similar to the first application, user selected applications, and system defined applications.

In accordance with another aspect of the disclosure, a method for managing operations of an electronic device is provided. The method includes detecting, by a functionality management unit, an input performed on a first item of a first application displayed on a display screen of the electronic device. Further, the method includes causing, by the functionality management unit, to display at least one second items associated with at least one second application on the display screen of the electronic device. The method further includes detecting, by the functionality management unit, an association event performed on the at least one second item associated with the at least one second application displayed on the display screen of the electronic device. Furthermore, the method includes dynamically associating, by the functionality management unit, the at least one second item associated with the at least one second application with the first item of the first application based on the association event.

In accordance with another aspect of the disclosure, an electronic device for managing operations is provided. The electronic device includes at least one processor, a storage coupled to the at least one processor, and a functionality management unit coupled to the at least one processor, the functionality management unit is configured to detect an input performed on an first item associated with a first application displayed on a display screen of the electronic device, wherein the first item is associated with at least one second item associated with at least one second application, and perform at least one operation corresponding to the at least one second item associated with the at least one second application based on the first item.

In accordance with another aspect of the disclosure, an electronic device for managing operations is provided. The electronic device includes at least one processor, a storage coupled to the at least one processor, and a functionality management unit coupled to the at least one processor, the functionality management unit is configured to detect an input performed on an first item of a first application displayed on a display screen of the electronic device, cause to display at least one second items associated with at least one second application on the display screen of the electronic device, detect an association event performed on the at least one second item associated with the at least one second application displayed on the display screen of the electronic device and dynamically associate the at least one second item associated with the at least one second application with the first item of the first application based on the association event.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates various units of an electronic device including a functionality management unit/module for managing operations and functionality of applications, according to an embodiment of the disclosure;

FIG. 2 is a flow diagram illustrating a method for managing operations of one or more applications of an electronic device, according to an embodiment of the disclosure;

FIG. 3 is a flow diagram illustrating various operations for dynamically associating at least one functional data item associated with interactive data item of a first application, according to an embodiment of the disclosure;

FIG. 4 is a flow diagram illustrating various operations for managing listing of one or more functional data items on a display screen of an electronic device, according to an embodiment of the disclosure;

FIGS. 5A and 5B illustrate an example scenario in which the one or more functional data items are displayed on a display screen, according to an embodiment of the disclosure;

FIG. 6 is a flow diagram illustrating various operations for listing at least one functional data item on a display screen of an electronic device, according to an embodiment of the disclosure;

FIGS. 7A, 7B, and 7C illustrate an example scenario in which at least one operation/action corresponding to at least one functional data item is associated with a second application is performed by the electronic device, according to an embodiment of the disclosure;

FIGS. 8A, 8B, 8C, 8D, 8E, 8F, and 8G illustrate another example scenario in which at least one operation/action corresponding to at least one functional data item is associated with a second application is performed by the electronic device, according to an embodiment of the disclosure;

FIGS. 9A, 9B, 9C, and 9D illustrate yet another example scenario in which at least one operation/action corresponding to at least one functional data item is associated with a second application is performed by the electronic device, according to an embodiment of the disclosure;

FIGS. 10A, 10B, 10C, and 10D illustrate an example scenario in which a first application is associated with a timer-clock application, according to an embodiment of the disclosure;

FIGS. 11A, 11B, and 11C illustrate an example scenario in which the at least one data network type is associated with the at least one interactive data item of a first application, according to an embodiment of the disclosure;

FIGS. 12A, 12B, and 12C illustrate an example scenario in which the at least one mobile data network type is associated with the at least one interactive data item of a first application, according to an embodiment of the disclosure;

FIGS. 13A, 13B, and 13C illustrate an example scenario in which the either at least one mobile data network type or data network type is associated with the at least one interactive data item of a first application (browser application), according to an embodiment of the disclosure; and

FIG. 14 illustrates a computing environment implementing the method for managing operations of an electronic device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the various embodiments herein can be practiced and to further enable those skilled in the art to practice the various embodiments herein. Accordingly, the examples should not be construed as limiting the scope of the various embodiments herein.

As is traditional in the field, various embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

Accordingly, the various embodiments herein provide a method for managing operations of an electronic device. The method includes detecting, by a functionality management unit, an input performed on an interactive data item associated with a first application displayed on a display screen of the electronic device, wherein the interactive data item is associated with at least one functional data item associated with at least one second application. Further, the method includes performing, by the functionality management unit, at least one operation corresponding to the at least one functional data item associated with the at least one second application based on the interactive data item.

Accordingly, the various embodiments herein provide a method for managing operations of an electronic device. The method includes detecting, by a functionality management unit, an input performed on an interactive data item of a first application displayed on a display screen of the electronic device. Further, the method includes causing, by the functionality management unit, to display at least one functional data items associated with at least one second application on the display screen of the electronic device. Further, the method includes detecting, by the functionality management module, an association event performed on the at least one functional data item associated with the at least one second application displayed on the display screen of the electronic device. Furthermore, the method includes dynamically associating, by the functionality management module, the at least one functional data item associated with the at least one second application with the interactive data item of the first application based on the association event.

Unlike systems and methods of the related art, the proposed method allows the user of the electronic device an option to enhance the functionalities of the applications (including third party applications) by creating and displaying a customized window list including the at least one functional data item.

Unlike the systems and methods of the related art, the proposed method can therefore allow the user to opportunistically associate the pre-defined functionalities of one application (first application) with another application (second application).

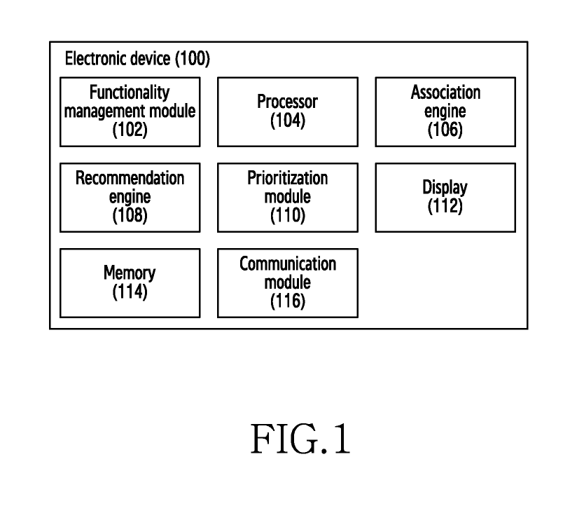

Referring now to the drawings, and more particularly to FIGS. 1 to 4, 5A and 5B, 6, 7A to 7C, 8A to 8G, 9A to 9D, 10A to 10D, 11A to 11C, 12A to 12C, 13A to 13C, and 14, where similar reference characters denote corresponding features consistently throughout the figures, there are shown preferred embodiments.

FIG. 1 illustrates various units/components of an electronic device 100 including a functionality management module 102 for managing operations and functionality of applications, according to an embodiment of the disclosure.

In an embodiment, referring to FIG. 1, the electronic device 100 can be, for example, a laptop, a desktop computer, a mobile phone, a smart phone, personal digital assistants (PDAs), a tablet, a phablet, a consumer electronic device, a dual display device, or any other electronic device. Further, the electronic device 100 can be a wearable device such as, for example, a smart watch, a smart bracelet, a smart glass, or the like. In another embodiment, the electronic device 100 can be for e.g., internet of things (IoT) devices.

The electronic device 100 can include (or, be associated with) a display or display screen 112 (e.g., a cathode ray tube (CRT), a liquid crystal display (LCD), a light-emitting diode (LED)) being interfaced with the processor 104 (e.g., at least one processors, a hardware unit, an apparatus, a central processing unit (CPU), a graphics processing unit (GPU)), a functionality management module 102, an association engine 106, a recommendation engine 108, and a prioritization module 110; a memory 114, and a communication module 116. At least one of the functionality management module 102, the association engine 106, the recommendation engine 108, and the prioritization module 110 can be implemented as at least one processor or a part of the processor 104.

The display screen 112, coupled to the functionality management module 102, can be configured to detect an input performed on an first item, which may be a first display item, interactive item, interactive feature or interactive data item, associated with a first application displayed on the display screen of the display of the electronic device 100, wherein the interactive item is associated with at least one second item, which may be a second display item, functional item, function feature or functional data item associated with at least one second application. The input may be, for example, gestures such as, for e.g., drag and drop gesture, touch, swipe, pinch, rail, hover, haptic, long press, or the like. The interactive data item may be, for example, an indicium (or indicia), graphical element (e.g., icon, data item, etc.) which when triggered (by the user) may navigate the user to a main screen/main window of the first application, and thereupon the user can perform one or more operations corresponding to interactive features associated with the first application. The interactive feature can be, for e.g., one or more features which are dependent on the views of the user; triggered by the user interaction and run as per the user navigation. In another embodiment, the interactive item may be, for example, one or more data items displayed within (main window) the display screen 112/display area of the first application (for e.g., contact-A (i.e., interactive data item) in a contact application (i.e., first application)).

Further, the functionality management module 102 can be configured to perform at least one operation corresponding to the at least one functional feature, functional item or functional data item associated with the at least one second application based on the interactive item. The functional feature, functional item, or functional data item may be, for example, a graphical element (e.g., icon, data item, etc.) associated with one or more functionalities (i.e., functionalities of the interactive features) of the second application. For e.g., calling application (i.e., second application) may include a call functional icon/indicia (i.e., functional data item) which when triggered (by the user) may perform the operation such as initiating a call (e.g., voice call, data call, etc.) respectively. In an example, selecting a contact from a contact list of a contact application and providing the input (e.g., touch) on the voice call icon (i.e., functional data item) may initiate the call with the selected contact. In another example, the at least one functional data item associated with a Wi-Fi application may include e.g., a Wi-Fi secure mode and a Wi-Fi insecure mode. Similarly, a mobile data network may include at least one functional data item indicating type of mobile network services (second generation (2G), third generation (3G), and fourth generation (4G)) compatible with the electronic device 100 respectively.

In another embodiment of the disclosure, the functionality management module 102 can be configured to detect the input (as discussed above) performed on an interactive data item (as discussed above) of a first application displayed on a display screen 112 of the electronic device 100. Further, the functionality management module 102 can be configured to cause the display screen 112 to display at least one functional data item (as discussed above) associated with at least one second application of the electronic device 100. The first application and the second application can be, for example, a message application, a social networking site (SNS) application, an e-mail application, a gallery application, a voice call application, or any other application available in the electronic device 100. Further, the functionality management module 102 can be configured to detect an association event performed on the at least one functional data item associated with the at least one second application displayed on the display screen 112 of the electronic device 100. The association event may be a gesture input such as, for e.g., drag and drop gesture, touch, swipe, pinch, rail, hover, haptic, long press, double click or the like. Furthermore, the functionality management module 102 can be configured to dynamically associate the at least one functional data item associated with the at least one second application with the interactive data item of the first application based on the association event.

The association engine 106, coupled to the functionality management module 102, can be configured to create a contextual relationship between the interactive data item associated with the first application and the at least one functional data item associated with the at least one second application. Further, the association engine 106 can be configured to display the one or more functional data items of the at least one second application associated with the first application.

Further, the recommendation engine 108 can be configured to provide one or more recommendations to the user based on the one or more parameters. The recommendation may include, for e.g., recommending one or more functional data items to be displayed on the display screen 112. The one or more parameters may include for e.g., user usage history, user preferences, etc.

The prioritization module 110 can be configured to display the at least one functional data item in accordance to a priority associated with each of the functional data items. The priority can be defined by the processor 120/functionality management module 102, user defined, event based, or the like.

Further, the at least one functional data item, associated with the at least one second application, to be displayed is dynamically determined based on at least one of applications frequently used with the first application, frequently used with applications similar to the first application, user selected applications, and system defined applications based on their cross-functional similarities.

The memory 114 may include one or more computer-readable storage media. The memory 114 may include non-volatile storage elements. Examples of such non-volatile storage elements may include magnetic hard disk, optical disks, floppy disks, flash memories, or forms of erasable programmable read-only memory (EPROM) or electrically erasable programmable ROM (EEPROM). In addition, the memory 114 may, in some examples, be considered a non-transitory storage medium. The term “non-transitory” may indicate that the storage medium is not embodied in a carrier wave or a propagated signal. However, the term “non-transitory” should not be interpreted that the memory 114 is non-movable. In some examples, the memory 114 can be configured to store larger amounts of information than a memory. In certain examples, a non-transitory storage medium may store data that can, over time, change (e.g., in random-access memory (RAM) or cache). The communication module 116 is configured for communicating internally between units and with external devices via one or more networks.

Although the FIG. 1 shows units/components of the electronic device 100 but it is to be understood that other embodiments are not limited thereon. For example, in other embodiments of the disclosure, the electronic device 100 may include less or more number of units. Further, the labels or names of the units are used only for illustrative purpose and does not limit the scope of the disclosure. One or more units can be combined together to perform same or substantially similar function to that of the electronic device 100.

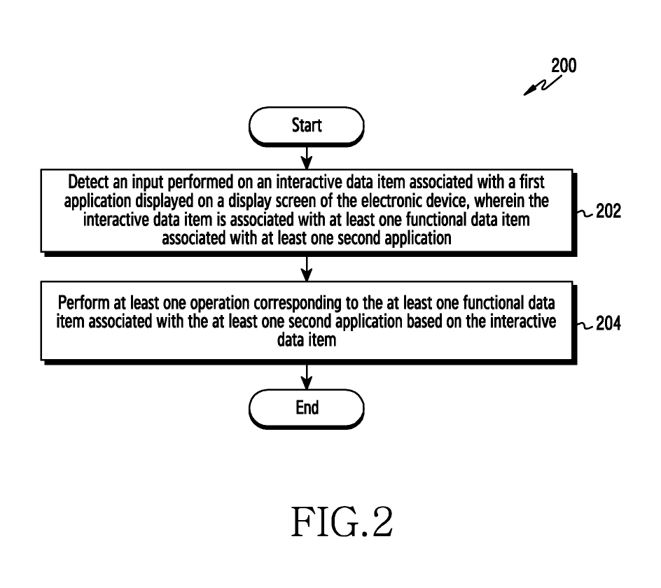

FIG. 2 is a flow diagram 200 a method for managing operations of one or more applications of the electronic device 100, according to an embodiment of the disclosure.

Referring to FIG. 2, at operation 202, the method includes detecting the input performed on the interactive data item associated with the first application displayed on the display screen 112 of the electronic device 100, wherein the interactive data item is associated with at least one functional data item associated with at least one second application. In an embodiment of the disclosure, the method allows the functionality management module 102, communicatively coupled to the display screen 112, to detect the input performed on the interactive data item associated with the first application displayed on the display screen 112 of the electronic device 100, wherein the interactive data item is associated with at least one functional data item associated with at least one second application.

At operation 204, the method includes performing the at least one operation corresponding to the at least one functional data item associated with the at least one second application based on the interactive data item. In an embodiment of the disclosure, the method allows the functionality management module 102 to be configured to perform the at least one operation corresponding to the at least one functional data item associated with the at least one second application based on the interactive data item.

The various actions, acts, blocks, operations, or the like in the method of the flow diagram 200 may be performed in the order presented, in a different order or simultaneously. Further, in some embodiments of the disclosure, some of the actions, acts, blocks, operations, or the like may be omitted, added, modified, skipped, or the like without departing from the scope of the disclosure.

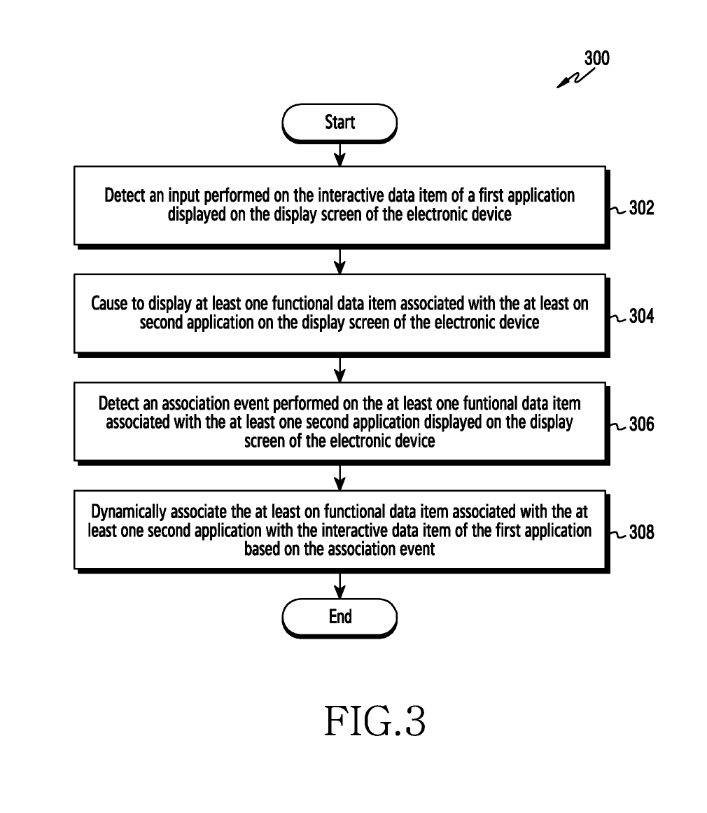

FIG. 3 is a flow diagram illustrating various operations for dynamically associating at least one functional data item associated with interactive data item of a first application, according to an embodiment of the disclosure.

Referring to FIG. 3, at operation 302, the method includes detecting the input performed on the interactive data item of the first application displayed on the display screen of the electronic device 100. In an embodiment of the disclosure, the method allows the functionality management module 102 to detect the input performed on the interactive data item of the first application displayed on the display screen of the electronic device 100.

At operation 304, the method includes causing to display the at least one functional data item associated with the at least one second application on the display screen 112 of the electronic device 100. In an embodiment of the disclosure, the functionality management module 102 can be configured to display the at least one functional data item associated with the at least one second application on the display screen 112 of the electronic device 100.

At operation 306, the method includes detecting an association event performed on the at least one functional data item associated with the at least one second application displayed on the display screen 112 of the electronic device 100. For example, the association event may be an action of selecting the at least one functional item associated with the at least one second application displayed. The association event may be a gesture input such as, for e.g., drag and drop gesture, touch, swipe, pinch, rail, hover, haptic, long press, double click or the like. For another example, the association event may be an action of selecting the at least one functional item associated with the at least one second application and associating the selected at least one functional item with the at least one data item. In an embodiment of the disclosure, the functionality management module 102 can be configured to detect the association event performed on the at least one functional data item associated with the at least one second application displayed on the display screen 112 of the electronic device 100.

At operation 308, the method includes dynamically associating the at least one functional data item associated with the at least one second application with the interactive data item of the first application based on the association event. In an embodiment of the disclosure, the functionality management module 102 can be configured to dynamically associate the at least one functional data item associated with the at least one second application with the interactive data item of the first application based on the association event.

The various actions, acts, blocks, operations, or the like in the method of the flow diagram 300 may be performed in the order presented, in a different order or simultaneously. Further, in some embodiments of the disclosure, some of the actions, acts, blocks, operations, or the like may be omitted, added, modified, skipped, or the like without departing from the scope of the disclosure.

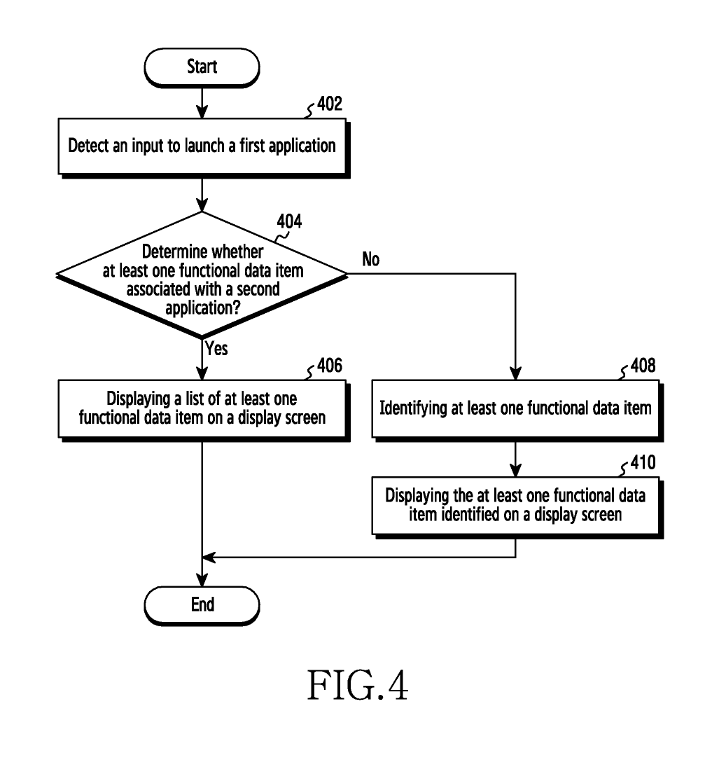

FIG. 4 is a flow diagram illustrating various operations for managing listing of one or more functional data items on the display screen 112 of the electronic device 100, according to an embodiment of the disclosure.

Referring to FIG. 4, at operation 402, the method includes detecting the input to launch the first application. In an embodiment of the disclosure, the functionality management module 102 can be configured to detect the input to launch the first application.

Once the first application is launched, then, at operation 404, the method determines whether the at least one functional data item associated with the second application is stored in association with the first application. In an embodiment of the disclosure, the method allows the functionality management module 102 to determine the at least one functional data item associated with the second application.

If at operation 404, the functionality management module 102 determines that the at least one functional data item of the second application is stored in association with the first application then, at operation 406, the method includes displaying a list of at least one functional data item on the display screen 112 of the electronic device 100. In an embodiment of the disclosure, the functionality management module 102 can be configured to display the list of at least one functional data item on the display screen 112 of the electronic device 100.

If at operation 404, the functionality management module 102 determines unavailability of the at least one functional data item, then, at operation 408, the method includes identifying at least one functional data item associated with the second application. In an embodiment of the disclosure, the method allows the functionality management module 102 to identify the at least one functional data item associated with the second application. The at least one functional data item associated with the second application may be identified from the at least one functional data item associated with the at least one second application frequently used with the first application, frequently used with applications similar to the first application, user selected applications, and system defined applications based on their cross-functional similarities.

At operation 410, the method includes displaying the at least one functional data item identified on the display screen 112 of the electronic device 100. In an embodiment of the disclosure, the functionality management module 102 displays the at least one functional data item identified on the display screen 112 of the electronic device 100.

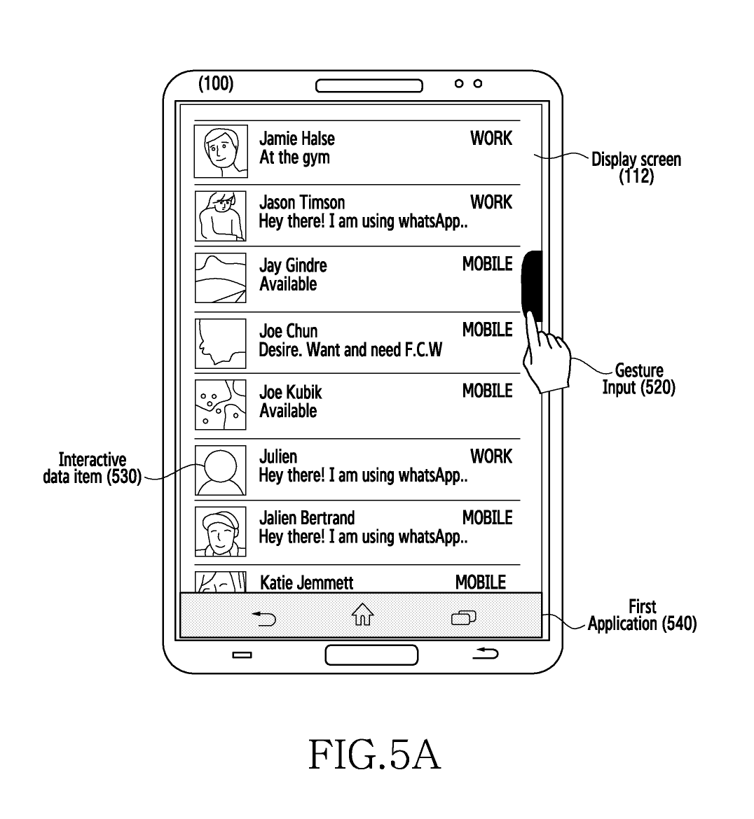

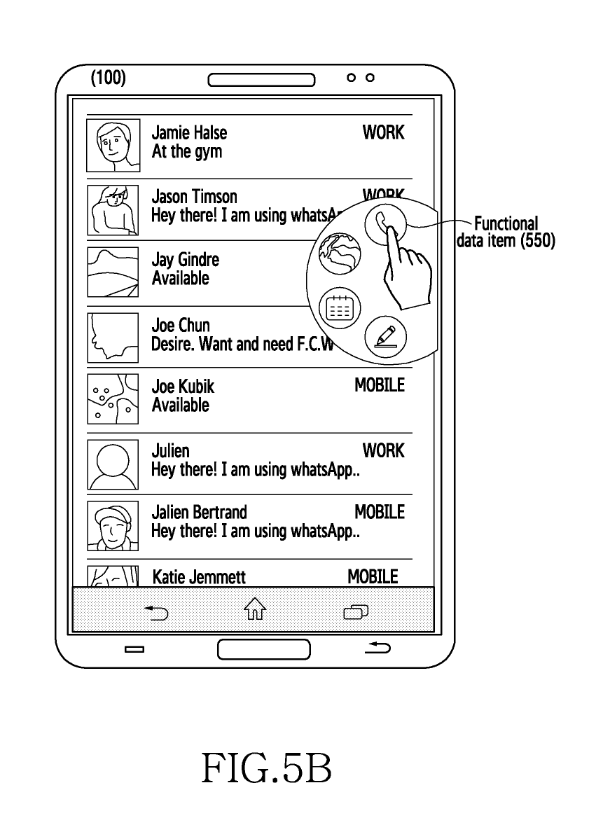

FIGS. 5A and 5B illustrate an example scenario in which the one or more functional data items are displayed on the display screen 112, according to an embodiment of the disclosure.

Referring to FIG. 5A, the display screen 112 of the electronic device 100 can be configured to display a first application 540 including at least one interactive data item 530 on the display screen 112. Once the display screen 112 detects a gesture input 520, the functionality management module 102 can be therefore display at least one functional data item 550 on the display screen 110. The at least one functional data item 550 can be displayed, for example, in a form of list, grid, graphical window, customizable window by the user, system defined settings, etc., as shown in the FIG. 5B. Further, the gesture input 520, the at least one functional data item 550 and the corresponding functionality associated therewith can be stored in the memory 114.

In another embodiment of the disclosure, the at least one functional data item 550 can be dynamically determined based on the contextual relationship between the first application 540 and second application. For example, if the context of the first application 540 is the SNS application then the at least one functional data item 550 listed by the functionality management module 102 can be browser application, calendar application, Voice call, etc.

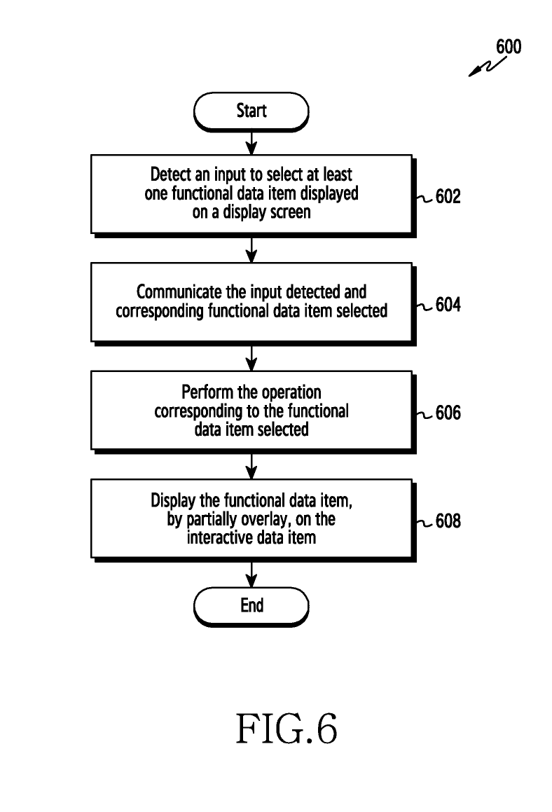

FIG. 6 is a flow diagram 600 illustrating various operations for listing at least one functional data item on the display screen 112 of the electronic device 100, according to an embodiment of the disclosure.

Referring to FIG. 6, at operation 602, the method includes detecting an input to select at least one functional data item displayed on the display screen 112 of the electronic device 100. In an embodiment of the disclosure, the functionality management module 102 can be configured to detect the input to select the at least one functional data item displayed on the display screen 112 of the electronic device 100. At least one interactive data item may also be displayed on the display screen 112 of the electronic device 100. The interactive data item may be associated with a first application. The at least one functional data item may be displayed in association with at least one interactive data item.

At operation 604, the method includes communicating the input detected and the corresponding functional data item, selected based on the input, to the memory 114. The method may identify an operation corresponding to the selected functional data item. The method may further identify at least one interactive data item associated with the selected functional data item. In an embodiment of the disclosure, the functionality management module 102 can be configured to communicate the input detected and the corresponding functional data item, selected based on the input, to the memory 114.

At operation 606, the method includes performing the operation corresponding to the functional data item selected. In an embodiment of the disclosure, the functionality management module 102 can be configured to perform the operation corresponding to the functional data item selected. The operation may include performing the operation corresponding to the functional data item with respect to the at least on interactive data item.

At operation 608, the method includes displaying the functional data item, by partially overlay, on the interactive data item. In an embodiment of the disclosure, the functionality management module 102 can be configured to display the functional data item, by partially overlay, on the interactive data item. The displaying the functional item may include displaying the window performing the functional data item associated with the second application with respect to the interactive data item associated with the first application.

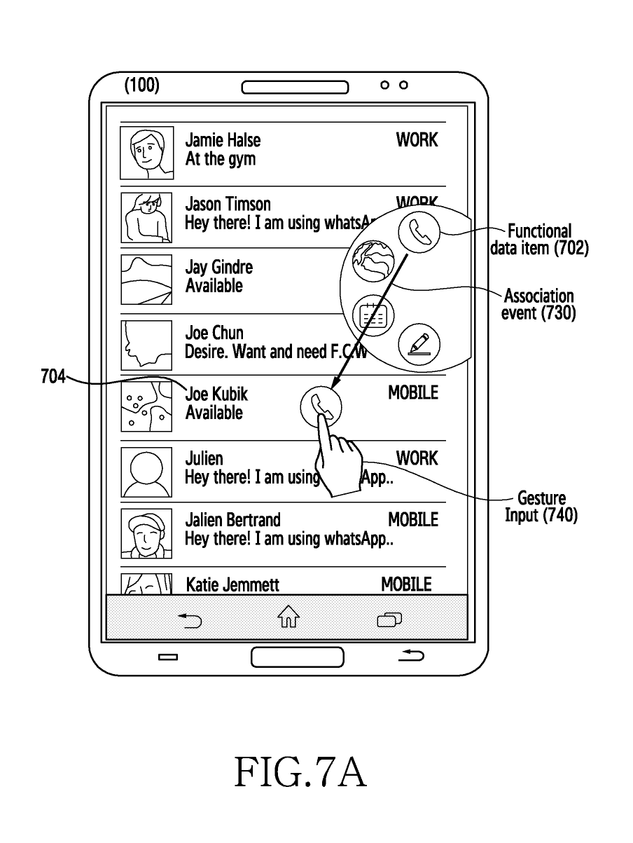

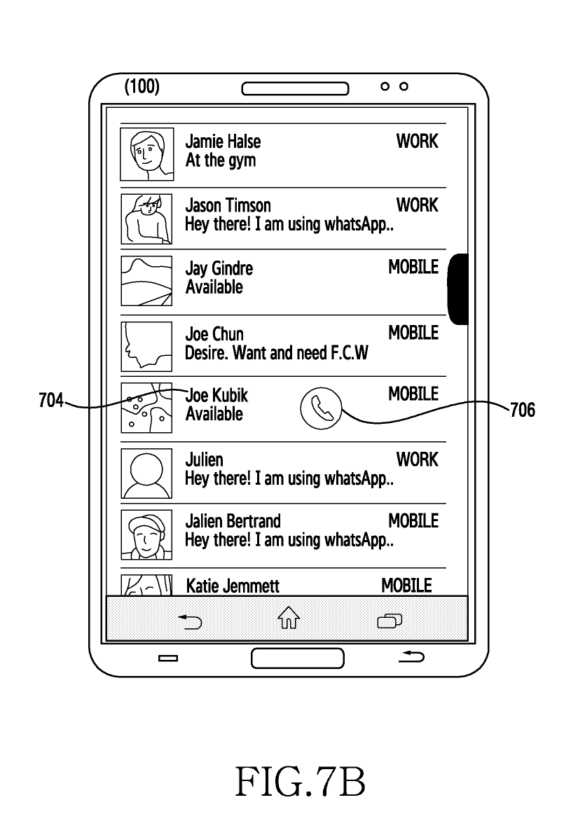

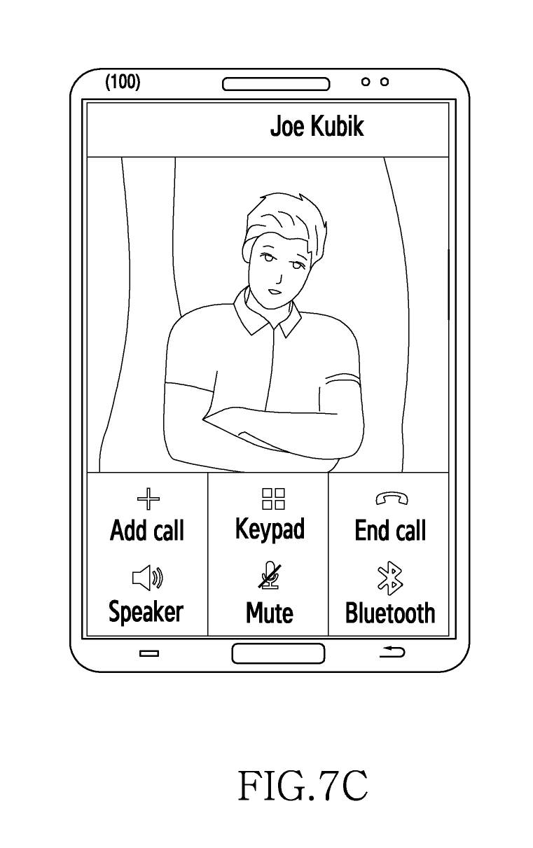

FIGS. 7A to 7C illustrate an example scenario in which at least one operation/action corresponding to at least one functional data item is associated with a second application is performed by the electronic device 100, according to an embodiment of the disclosure.

Referring to FIG. 7A, once the functionality management module 102 detects the association event 730 performed on the at least one functional data item associated with the at least one second application displayed on the display screen 112 of the electronic device 100, the functionality management module 102 can therefore dynamically associate the at least one functional item (associated with the at least one second application) with the at least one interactive data item of the first application. For example, if the user selects (e.g., through a drag gesture input 740) the voice call icon (i.e., functional data item 702) from the graphical window and overlay e.g., on the layout structure of the interactive data item (for e.g., contact “Joe” 704) of the first application (i.e., SNS application) through a drop gesture input (as shown in FIG. 7B), the functionality management module 102 can therefore dynamically associate the voice call application with the interactive data item. The voice call icon 706 displayed in the vicinity of the contact “Joe” 704 can indicate the contact “Joe” 704 is associated with the voice call icon 706 associated with the voice call application. Thus, the functionality management module 102 triggers the voice calling action/operation (as shown in the FIG. 7C) with the contact “Joe” from the SNS application (unlike triggering the data calling action as in the methods and systems of the related art). The user can simply touch “Joe” interactive item 704 from the SNS application display to perform the voice calling action/operation corresponding to the functional data item 702 to make a voice call to “Joe”.

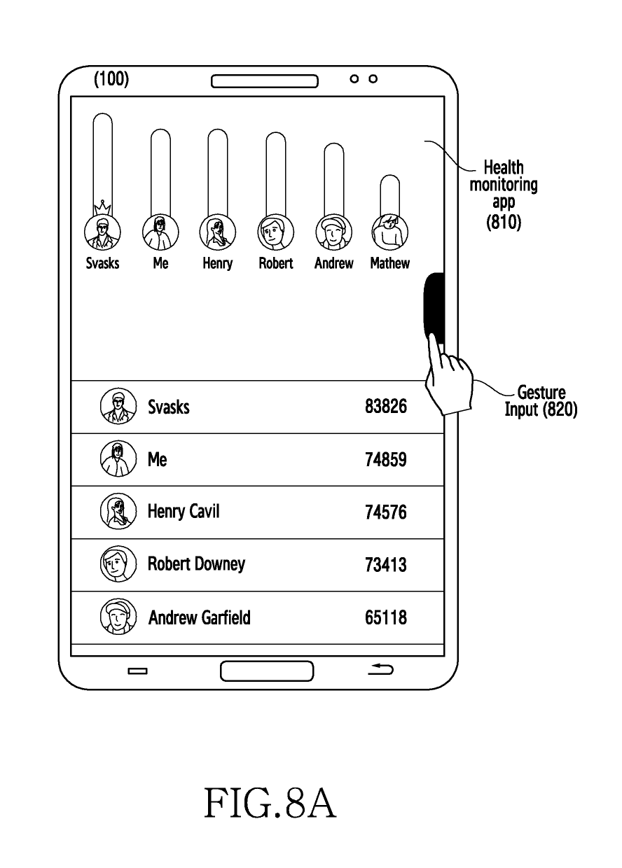

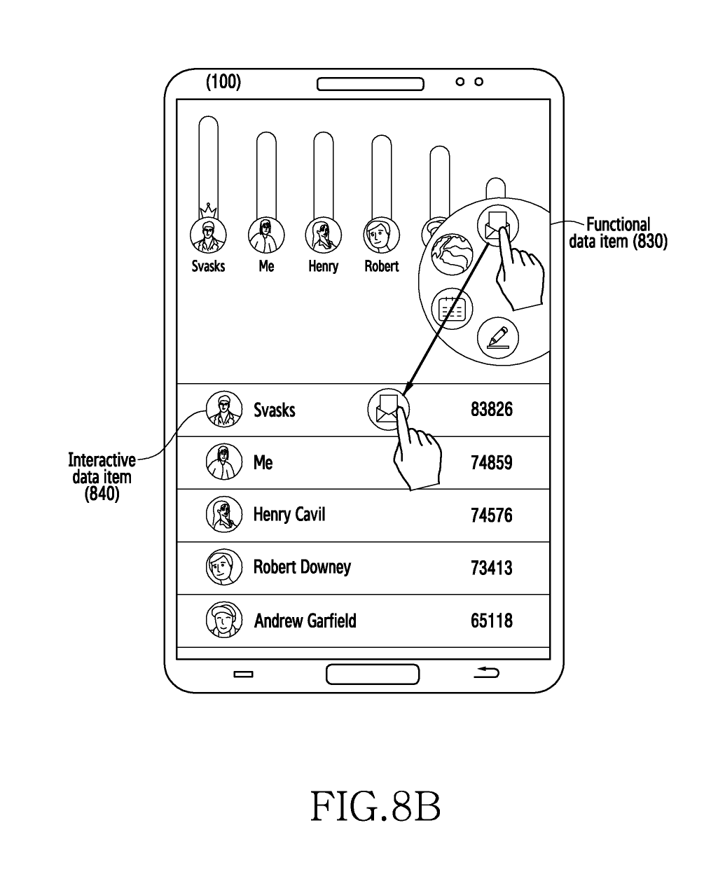

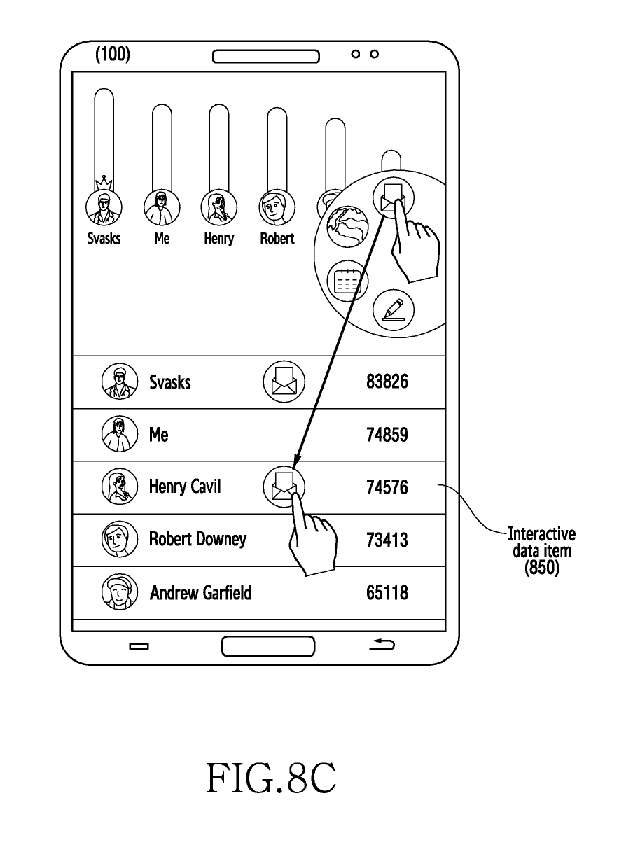

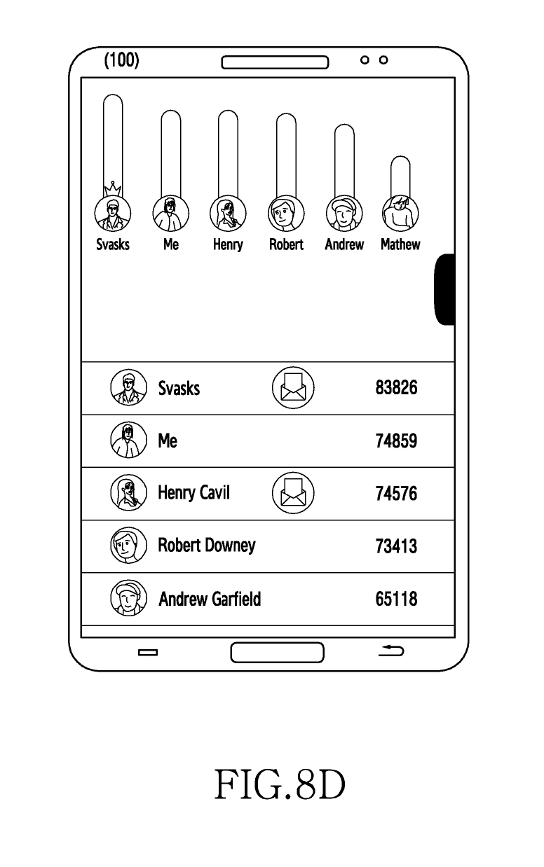

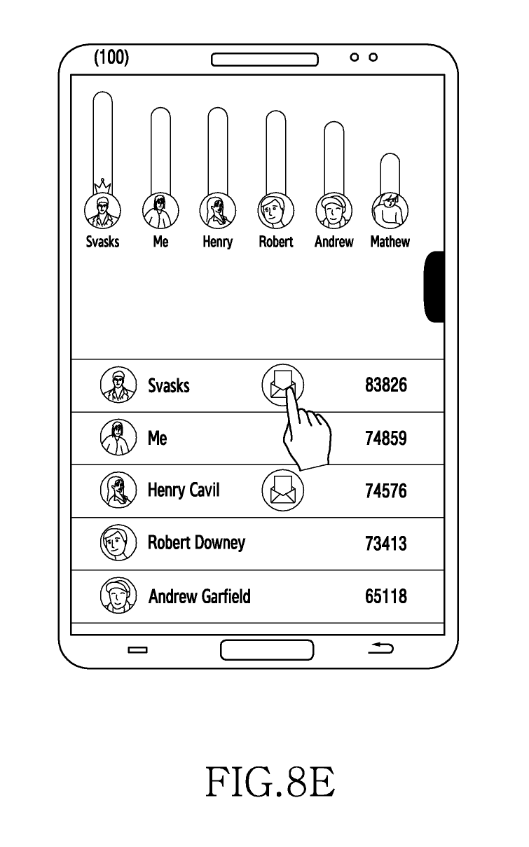

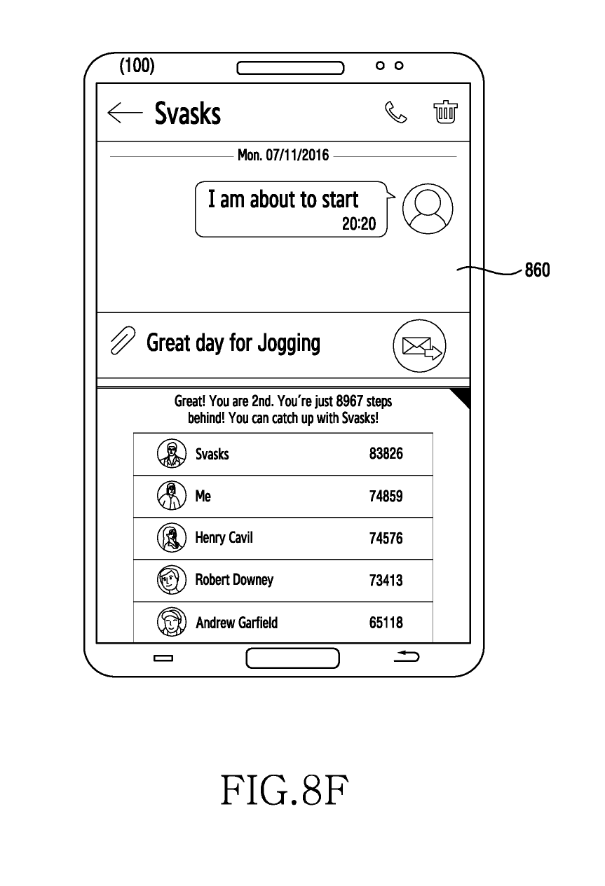

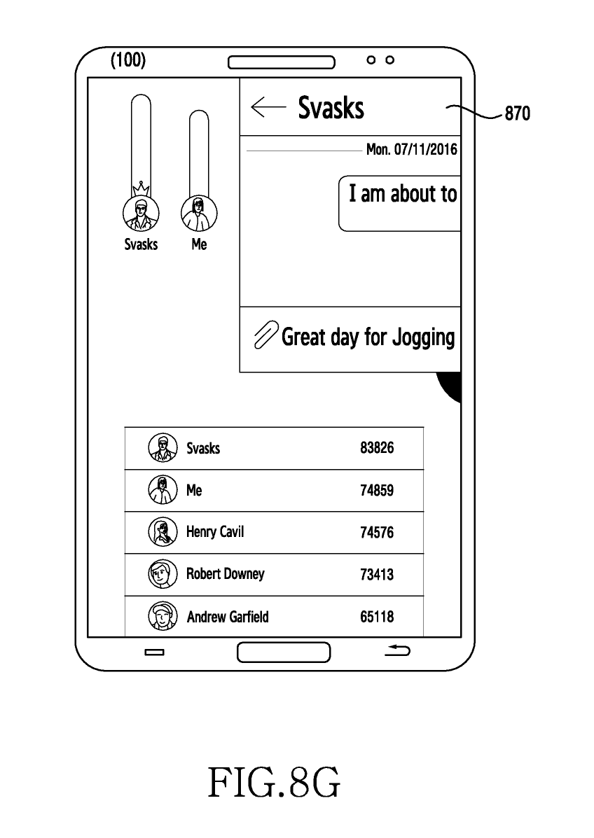

FIGS. 8A to 8G illustrate another example scenario in which at least one operation/action corresponding to at least one functional data item is associated with a second application is performed by the electronic device 100, according to an embodiment of the disclosure.

Referring to FIG. 8A, once the health monitoring application 810 is launched the functionality management module 102 can be configured to detect the at least one functional data item associated with the health monitoring application 810. The at least one functional data item (e.g., list, settings, or graphical window on the display screen 112) can be displayed on the display screen 112. Further, the display screen 112 detects a gesture input 820 to view the at least one functional data item 830 displayed on the display screen 112. Referring to FIG. 8B, the association engine 106 detects the association event performed (e.g., by the user) on the at least one functional data item 830 associated with the messaging application with respect to the at least one interactive data item 840 (e.g., user “Svas”). Further, the association engine 106 detects another association event performed (e.g., by the user) on the at least one functional data item 830 of the messaging application with respect to the at least one interactive data item 850 (e.g., user “Henry”) (as shown in FIG. 8C). Thus, the at least one functional data item 830 is overlay (top of the layout) on at least one interactive data item 840 and similarly overlay (top of the layout) on the at least one interactive data item 850 (as shown in FIG. 8D). Thus, the functionality management module 102 can be configured to associate the messaging application as an action for the user “Henry” and similar action to the user “Svas”. Thus, whenever the functionality management module 102 detects the gesture input (as shown in FIG. 8E) on the interactive data item 840 or the at least one functional data item overlay on the interactive data item 840, the messaging application, with the user “Svas” as recipient, is launched and the user can therefore interact with the user “Svas” through the messaging application (as shown in FIGS. 8F and 8G). Referring to FIG. 8F, the window 860 corresponding to the operation of the messaging application is displayed at a part of the display screen of the display screen 112. Referring to FIG. 8G, the window 870 corresponding to the operation of the messaging application is displayed overlay on the display screen of the display screen 112 where the health monitoring application 810 is launched.

Once the gesture input on the at least one interactive data item 840 is detected, the functionality management module 102 can be configured to display the contact details of the user “Svas” in the health monitoring application 810 only when the contact details are available in a contact database of the electronic device 100.

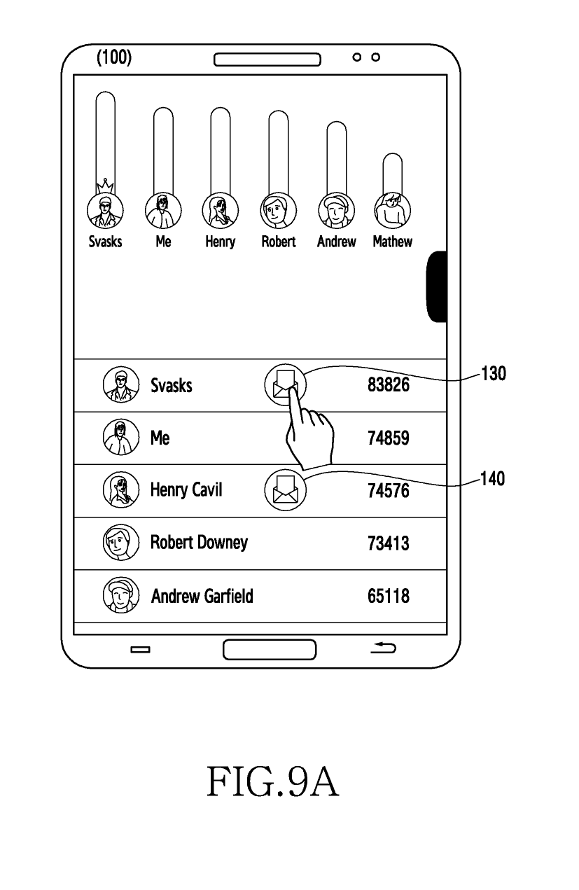

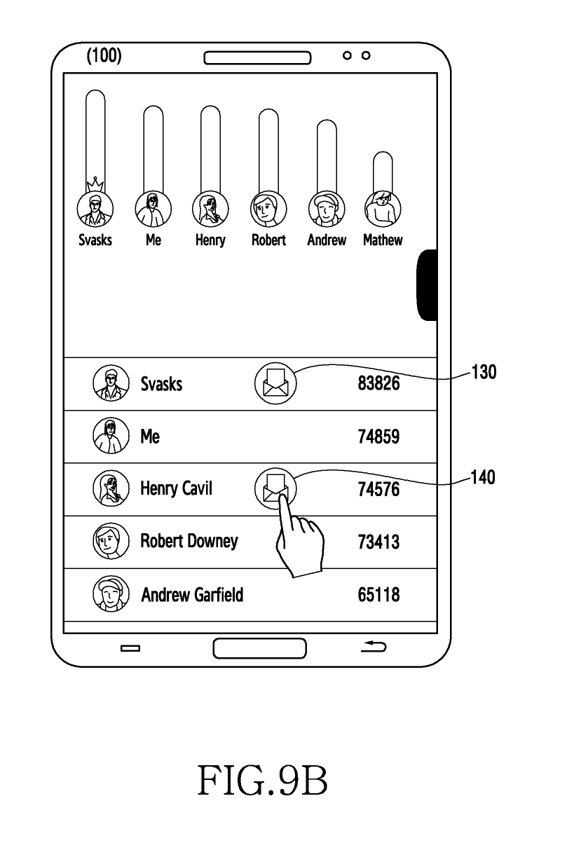

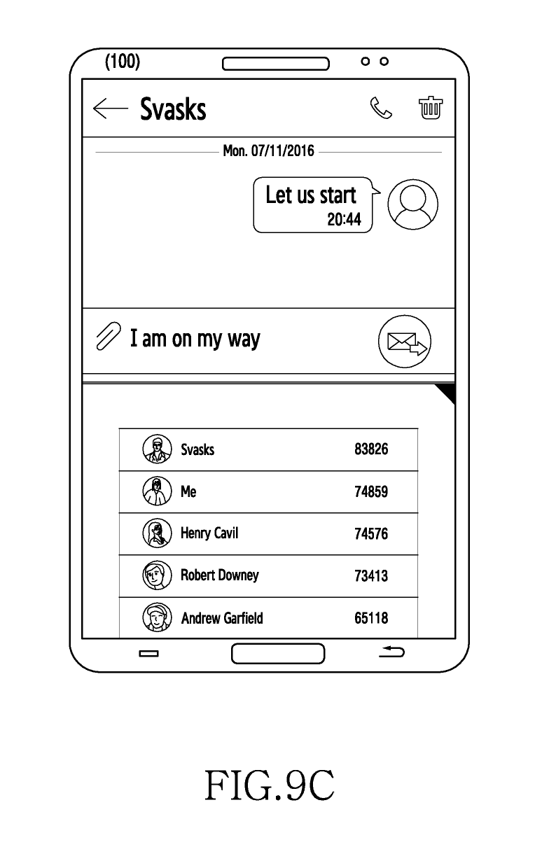

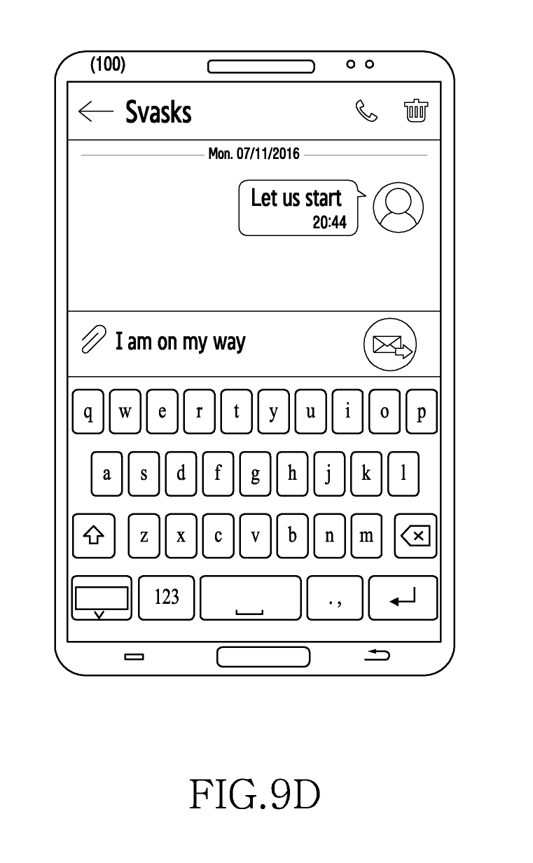

Similarly, when the gesture input is performed on both the interactive data items 130 and 140 corresponding actions are triggered, as shown in FIGS. 9A to 9D.

FIGS. 9A to 9D illustrate another example scenario in which at least one operation/action corresponding to at least one functional data item is associated with a second application is performed by the electronic device, according to an embodiment of the disclosure.

Referring to FIGS. 9A and 9B, functional data items associated with the interactive data items 130 and 140 may be selected. In accordance with the messaging application associated with the functional data items may be performed to message both “Svas” and “Henry” corresponding to the selected interactive data items 130 and 140. Therefore, the user may edit the message to “Svas” and “Henry” as shown in FIG. 9D.

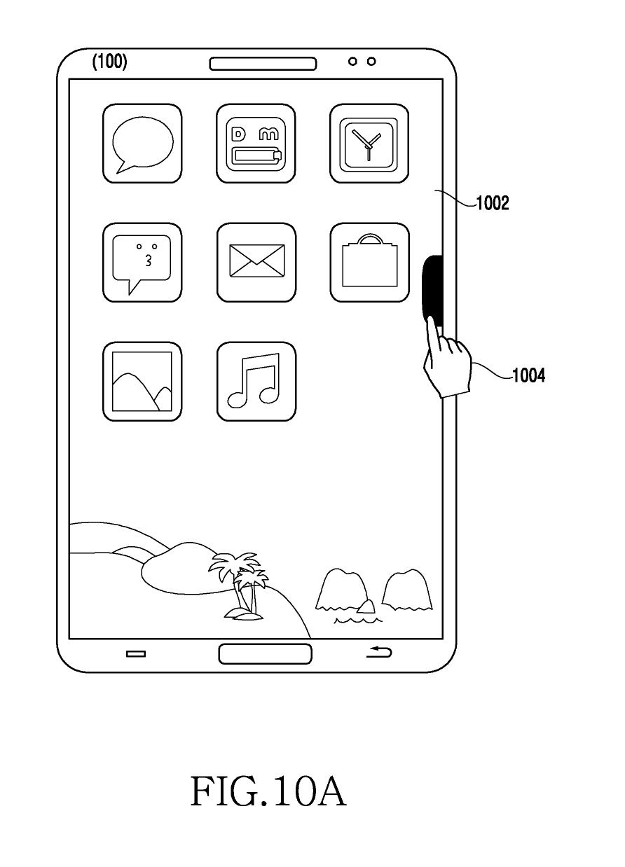

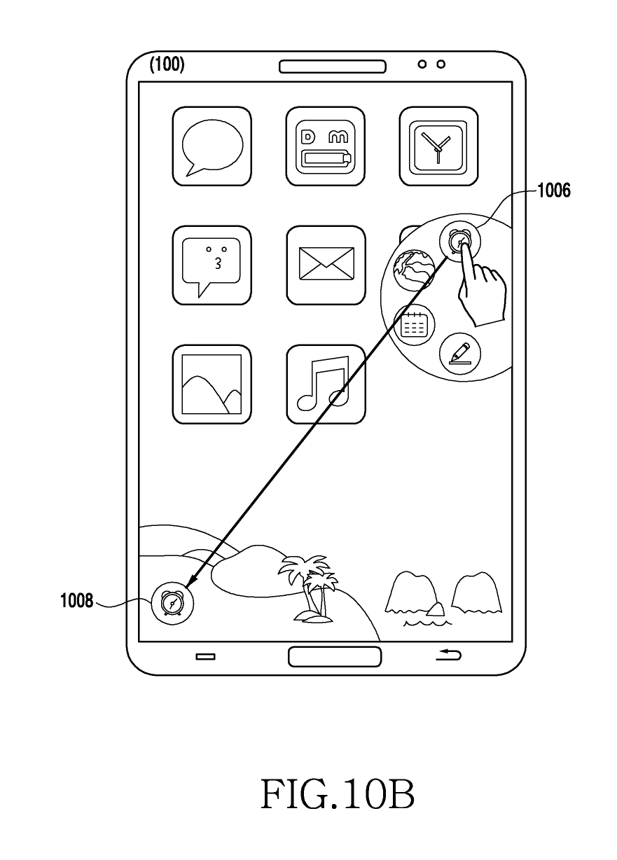

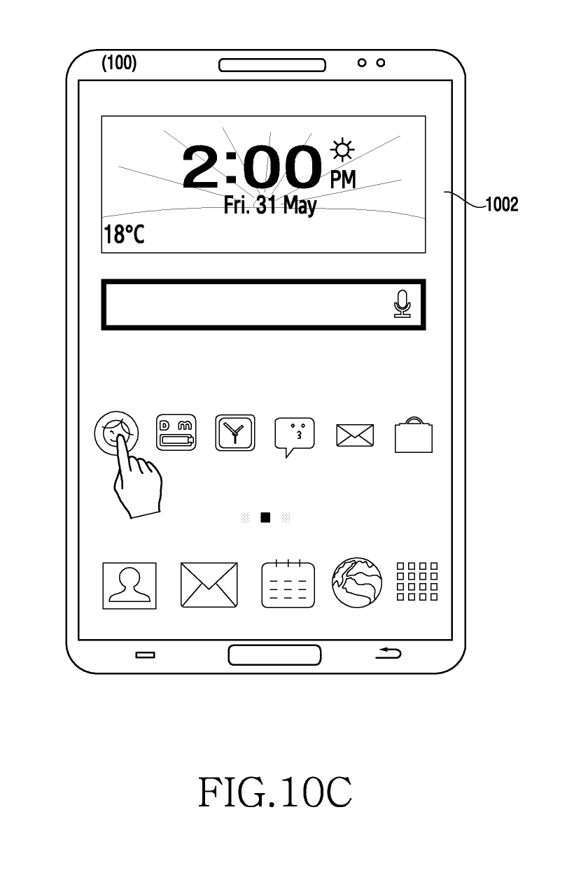

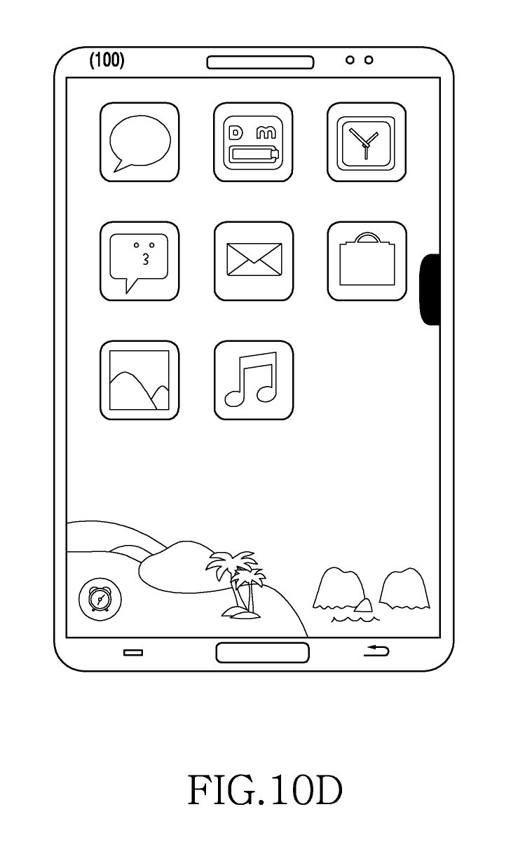

FIGS. 10A to 10D illustrate an example scenario in which the first application is associated with a timer-clock application, according to an embodiment of the disclosure.

Referring to FIG. 10A, once a first application 1002 (Kids mode) is launched the functionality management module 102 can be configured to determine whether at least one functional data item is associated with the first application 1002. The at least one functional data item (e.g., list, settings, or graphical window) can be displayed on the display screen 112. Further, the display screen 112 detects a gesture input 1004 to view the at least one functional data item 1006 displayed on the display screen 112. Referring to FIG. 10B, the association engine 106 detects the association event (e.g. a drag and drop gesture) performed (e.g., by the user) on the at least one functional data item 1006 associated with the timer clock application 1008 with respect to the first application 1002. Thus, whenever the first application 1002 is launched or activated in response to detecting the gesture input on the first application (as shown in FIG. 10C) the timer clock application 1008 associated with the first application also starts (as shown in the FIG. 10D). Further, the timer application stops when a pause event for first application 1002 is detected. Further, the functionality management module 102 can restart the timer clock application 1008 when the first application 1002 is in the foreground/running, and produce the total usage time when the first application 1002 is exited. Furthermore, the data (i.e. output of the timer clock application 1008, analysis) are stored in the memory 114.

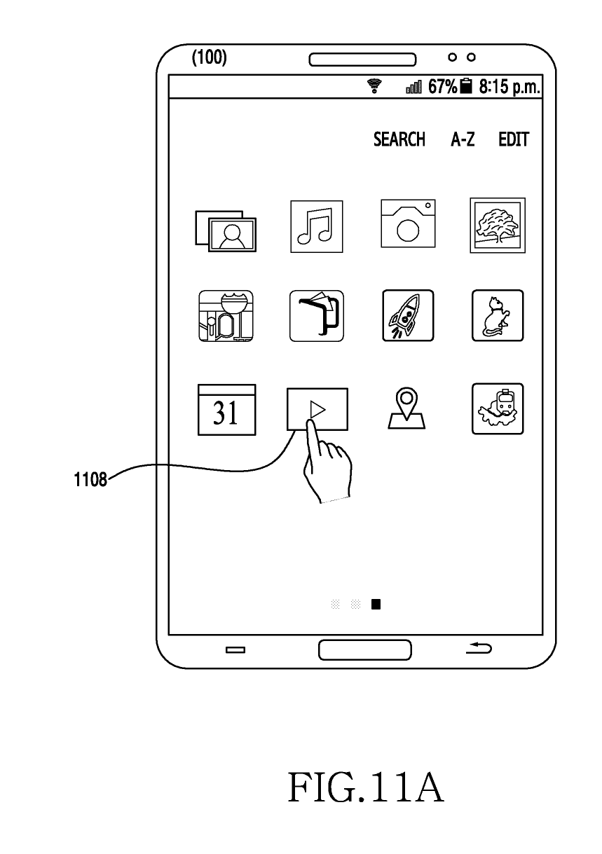

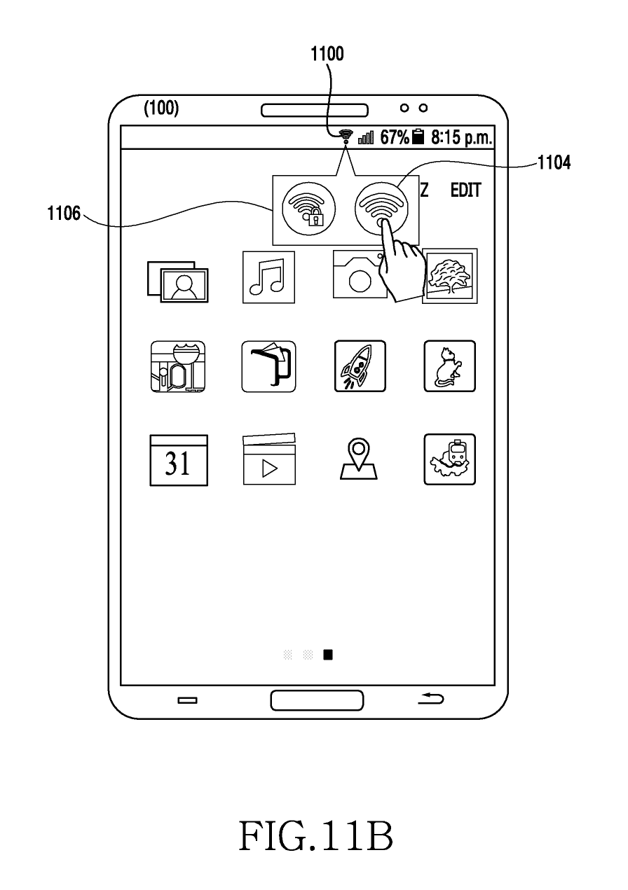

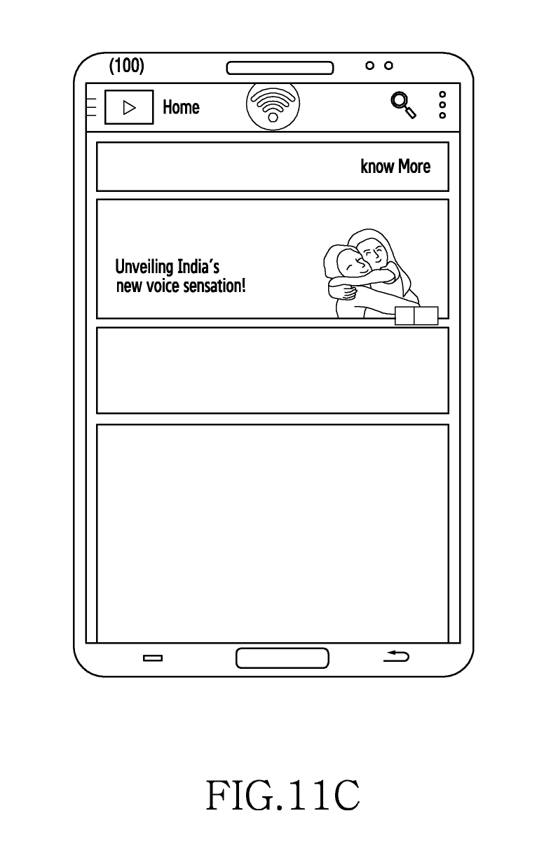

FIGS. 11A to 11C illustrate an example scenario in which the at least one data network type is associated with the at least one interactive data item of a first application, according to an embodiment of the disclosure.

The interactive data item associated with at least one first application may be associated with, for example, at least one functional data item i.e., Wi-Fi secure 1104 or the Wi-Fi insecure 1106 (i.e., open Wi-Fi network type) of Wi-Fi application 1100 displayed on to the display screen 112 of the electronic device 100 (as shown in the FIG. 11A). Thus, the user, by way of the functionality management module 102, can associate (association event) a video player application 1108 with the Wi-Fi insecure 1106 connection (as shown in FIG. 11B), thus the video player application 1108 may stream the content while the electronic device 100 is connected to the Wi-Fi insecure 1106 (as shown in the FIG. 11C).

In another embodiment of the disclosure, the functionality management module 102 can be automatically set the data network type based on the type of applications and/or requirement of the applications. For example, the video player application 1108 may consume more data bandwidth resources and may not require security therefore the functionality management module 102 can be configured to use the open Wi-Fi network (e.g., Wi-Fi insecure 1106) to stream the content of the video player application 1108.

Unlike systems and methods of the related art, the proposed method can allow the user to apply the functionality of the Wi-Fi insecure 1106 to the interactive element of the video player application 1108. Thus, the video player application 1108 can stream the content in the Wi-Fi insecure 1106 connection, thus obviating the functionality of the Wi-Fi insecure 1106 connection to be globally applied on other applications (with respect to the Wi-Fi insecure functionality 1106) of the electronic device 100.

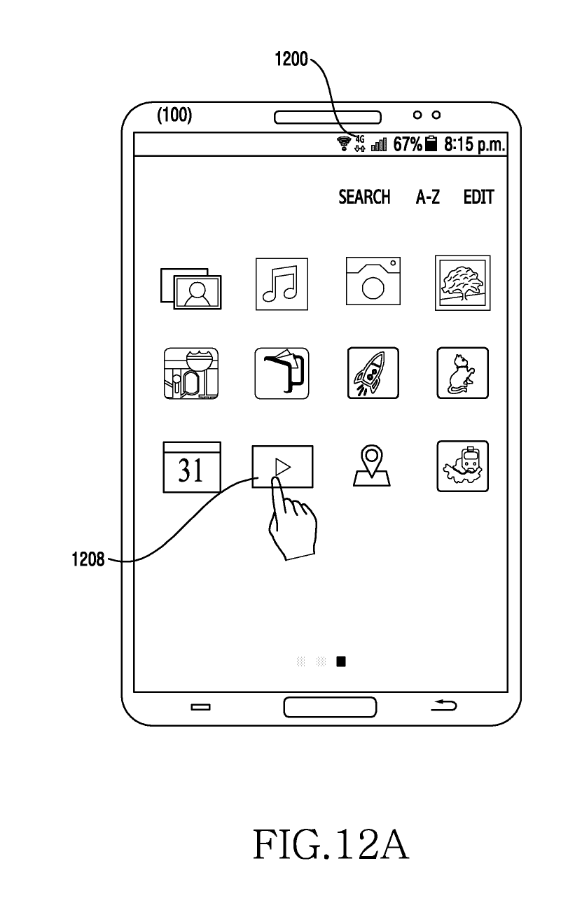

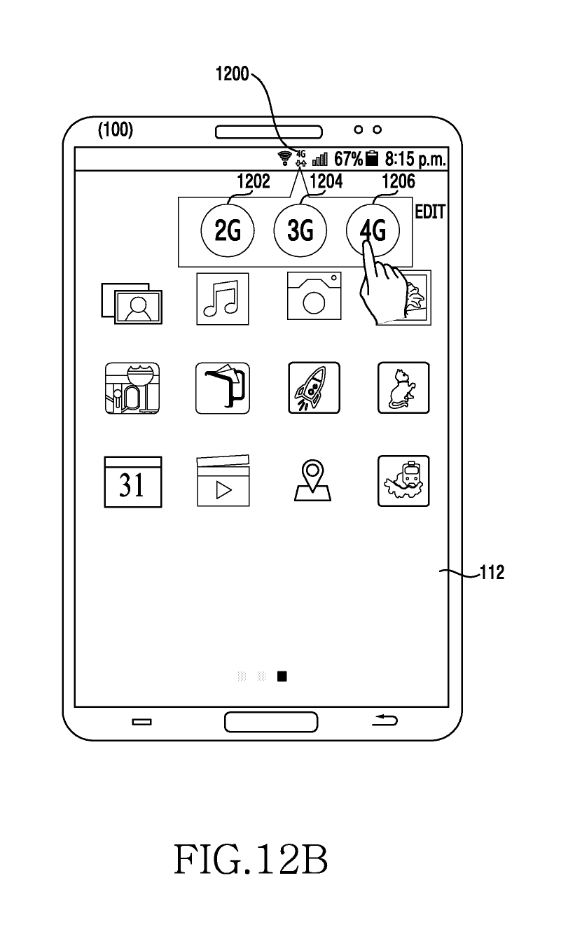

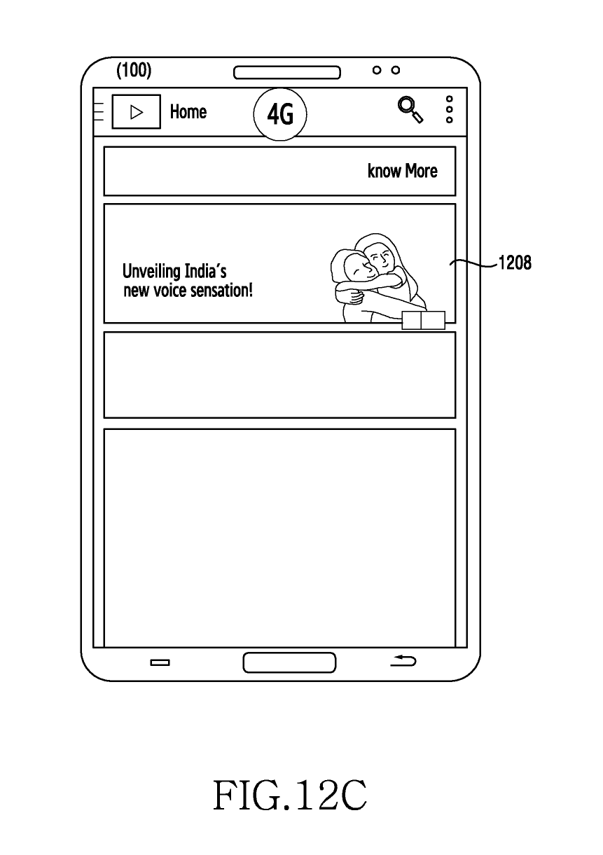

FIGS. 12A to 12C illustrate an example scenario in which the at least one mobile data network type is associated with the at least one interactive data item of a first application, according to an embodiment of the disclosure.

The interactive data item of the video player application 1208 may be selected by a user input. The second application i.e., a mobile data application 1200 includes, for example, at least one functional data item i.e., “2G” 1202, “3G” 1204 and “4G” 1206 displayed on to the display screen 112 of the electronic device 100. Thus, the user can associate (association event) the video player application 1208 with the functional data item “4G” (as shown in FIG. 12B), thus the video player application 1208 may stream the content while the electronic device 100 is connected to the “4G” network (as shown in the FIG. 12C).

In another embodiment of the disclosure, the functionality management module 102 can be automatically set the data network type based on the type of applications and/or requirement of the applications. For example, the video player application 1208 may consume more data bandwidth resources and may not require security therefore the functionality management module 102 can be configured to use open “4G” network to stream the content of the video player application 1208.

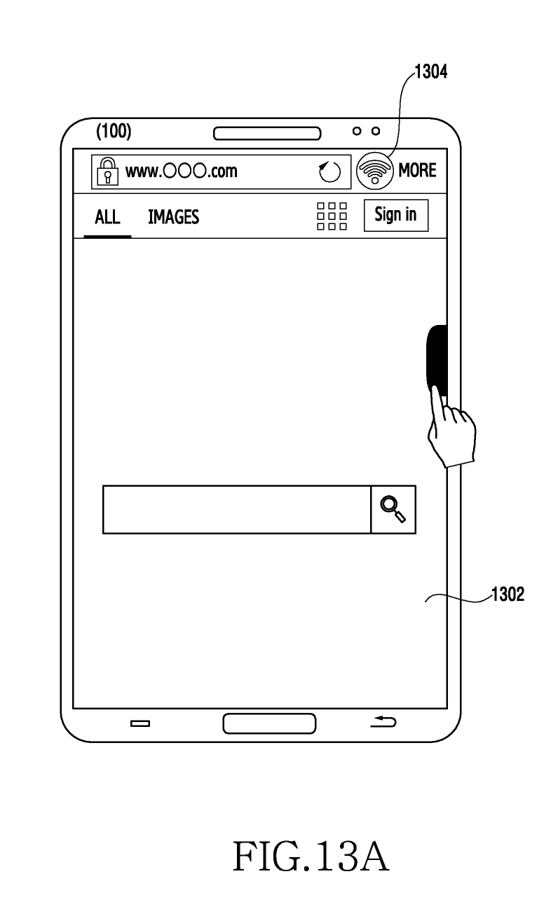

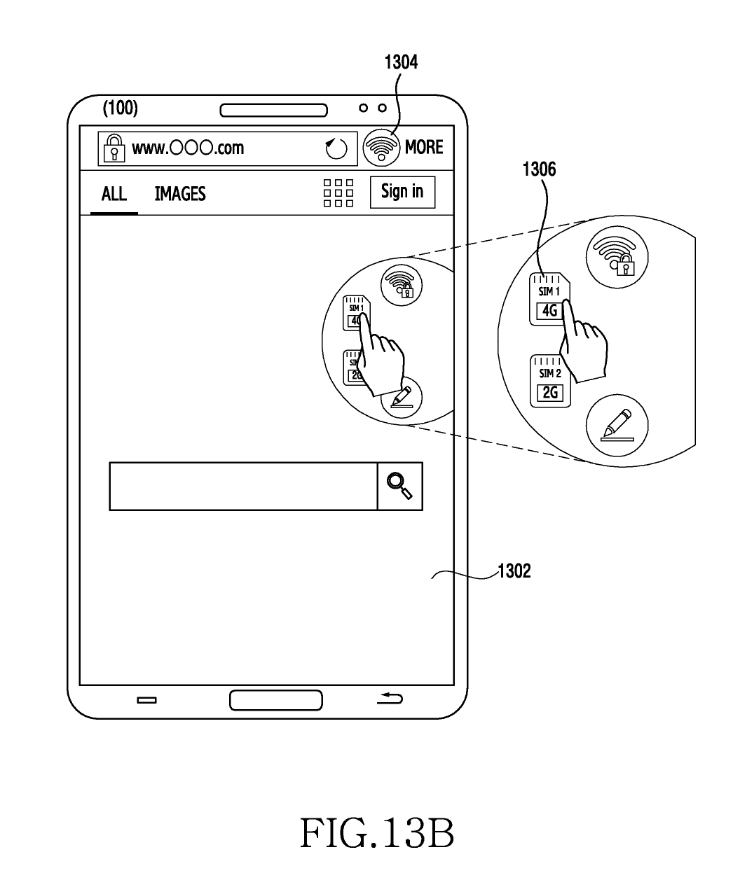

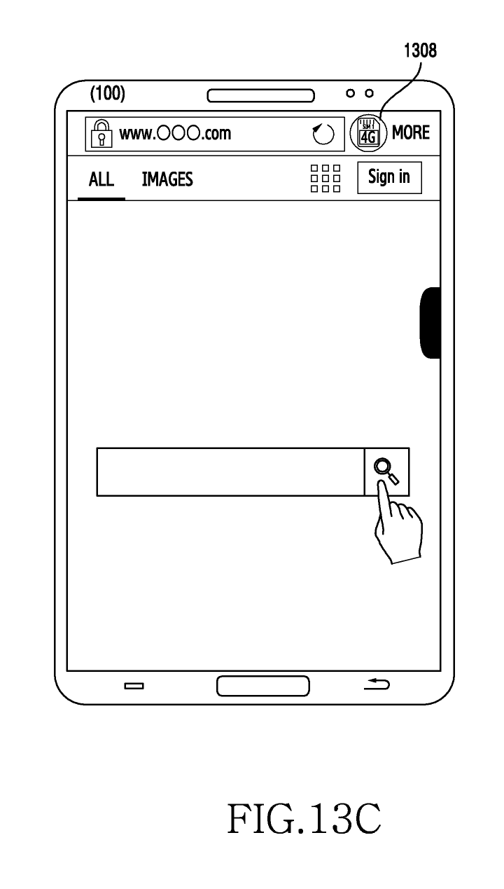

FIGS. 13A to 13C illustrate an example scenario in which the either at least one mobile data network type or data network type is associated with the at least one interactive data item of a first application (browser application), according to an embodiment of the disclosure.

Referring to FIG. 13A, a browser tab 1304 indicates the network type currently utilized by a browser application 1302, consider the browser application is using Wi-Fi insecure connection for its data search, thus according to the proposed method the functionality management module 102 can be configured to display the at least one functional data item 1306 of the at least one second application (i.e., contextual related to the browser application) (as shown in FIG. 13B). The at least one functional data item 1306 can be for e.g., type of mobile data network (2G, 3G, or 4G), type of data network (Wi-Fi secure, Wi-Fi insecure), notepad, and other functional data items which can be contextually associated/related with the browser application. Thus, the user can select the mobile data network (e.g., 4G) 1308 within the browser tab. Once the instance is associated with the mobile data network, the same mobile data network can be saved for future selection of same application instance or window. The associated mobile data network (e.g., 4G) 1308 may be displayed on the browser tab when the browser application 1302 is launched (as shown in the FIG. 13C). Alternatively, the association engine 106 can detect the data network that need secure connection like HTTPS for the browser application using secure connection for its data search.

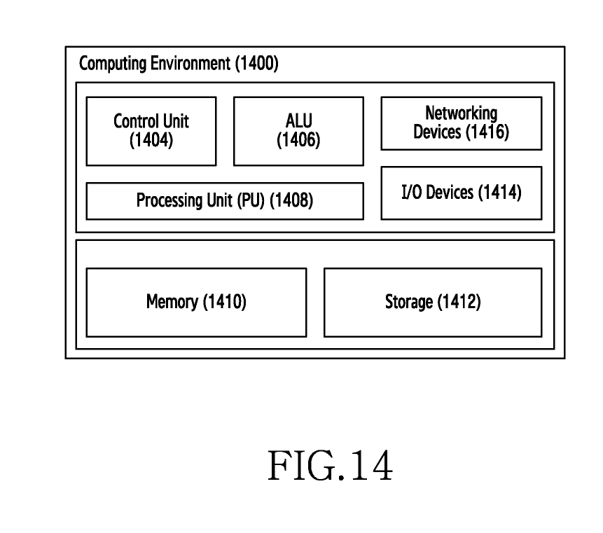

FIG. 14 illustrates a computing environment implementing the method for managing the operations of the electronic device 100, according to various embodiments of the disclosure.

Referring to FIG. 14, the computing environment 1400 comprises at least one processing unit 1408 that is equipped with a control unit 1404 (e.g., at least one processor) and an arithmetic logic unit (ALU) 1406, a memory 1410, a storage 1412, plurality of networking devices 1416 and a plurality input output (I/O) devices 1414. The processing unit 1408 is responsible for processing the instructions of the technique. The processing unit 1408 receives commands from the control unit in order to perform its processing. Further, any logical and arithmetic operations involved in the execution of the instructions are computed with the help of the ALU 1406.

The overall computing environment 1400 can be composed of multiple homogeneous and/or heterogeneous cores, multiple CPUs of different kinds, special media and other accelerators. The processing unit 1408 is responsible for processing the instructions of the technique. Further, the plurality of processing units 1408 may be located on a single chip or over multiple chips.

The technique comprising of instructions and codes required for the implementation are stored in either the memory 1410 or the storage 1412 or both. At the time of execution, the instructions may be fetched from the corresponding memory 1410 or storage 1412, and executed by the processing unit 1408.

In case of any hardware implementations various networking devices 1416 or external I/O devices 1414 may be connected to the computing environment to support the implementation through the networking unit and the I/O device unit.

The various embodiments disclosed herein can be implemented through at least one software program running on at least one hardware device and performing network management functions to control the elements. The elements shown in the FIGS. 1 to 4, 5A and 5B, 6, 7A to 7C, 8A to 8G, 9A to 9D, 10A to 10D, 11A to 11C, 12A to 12C, 13A to 13C, and 14 include blocks which can be at least one of a hardware device, or a combination of hardware device and software module.

While the disclosure has been shown and described with reference to various embodiments thereof, it will be understood by those skilled in the art that various changes in form and details may be made therein without departing from the spirit and scope of the disclosure as described by the appended claims and their equivalents.

What is claimed is:

1. A method for managing operations of an electronic device, the method comprising:
detecting an input performed on a first item associated with a first application and displayed on a display screen of the electronic device, wherein the first item is associated with at least one second item associated with at least one second application; and
performing at least one operation corresponding to the at least one second item associated with the at least one second application based on the input detected on the first item.

2. The method of claim 1, wherein the performing of the at least one operation comprises launching the first application associated with the first item.

3. The method of claim 2, wherein the performing of the at least one operation comprises displaying a window corresponding to the operation on at least part of the display screen.

4. The method of claim 3, wherein the window corresponding to the operation is displayed to partially overlay on the display screen where the first application is launched.

5. The method of claim 1, further comprising:
setting the first item to be associated with the at least one second item associated with the at least one second application by:
detecting a selection of the at least one second item displayed on the display screen, and
associating the at least one second item with the first item of the first application based on the detecting the selection of the at least one second item.

6. The method of claim 5, wherein the associating of the at least one second item with the first item of the first application is performed by further displaying the second item to partially overlay on the display screen.

7. The method of claim 5, wherein the associating of the at least one second item with the first item of the first application is performed by further displaying the selected second item in the vicinity of the first item displayed on the display screen where the first application is launched.

8. The method of claim 5, wherein the associating of the at least one second item with the first item of the first application is performed by further providing the at least one second item based on a contextual relationship between the first item associated with the first application and the at least one second item associated with the at least one second application.

9. The method of claim 5, wherein the at least one second item is displayed in accordance to a priority associated with each of the second item.

10. The method of claim 5, wherein the associating of the at least one second item with the first item of the first application is performed by further providing the at least one second item associated with the at least one second application based on at least one of applications frequently used with the first application, frequently used with applications similar to the first application, user selected applications, or system defined applications based on their cross-functional similarities.

11. An electronic device for managing operations, the electronic device comprising:
a display; and
at least one processor coupled to the memory and the display, and configured to:
detect an input performed on a first item associated with a first application and displayed on the display screen of the display, wherein the first item is associated with at least one second item associated with at least one second application, and
perform at least one operation corresponding to the at least one second item associated with the at least one second application based on the input detected on the first item.

12. The electronic device of claim 11, wherein the at least one processor is further configured to launch the first application associated with the first item.

13. The electronic device of claim 12, wherein the at least one processor is further configured to display a window corresponding to the operation on at least part of the display screen.

14. The electronic device of claim 13, wherein the window corresponding to the operation is displayed partially overlay on the display screen where the first application is launched.

15. The electronic device of claim 11, wherein the at least one processor is further configured to set the first item to be associated with the at least one second item associated with the at least one second application by detecting a selection of the at least one second item displayed on the display screen, and associating the at least one second item with the first item of the first application based on the detecting the selection of the at least one second item.

16. The electronic device of claim 15, wherein the at least one processor is further configured to display the second item to partially overlay on the display screen.

17. The electronic device of claim 15, wherein the at least one processor is further configured to associate the first item with the at least second item by further displaying the selected second item in the vicinity of the first item displayed on the display screen where the first application is launched.

18. The electronic device of claim 15, wherein the at least one processor is further configured to provide the at least one second item based on a contextual relationship between the first item associated with the first application and the at least one second item associated with the at least one second application.

19. The electronic device of claim 15, wherein the at least one second item is displayed in accordance to a priority associated with each of the second item.

20. The electronic device of claim 15, wherein the at least one processor is further configured to provide the at least one second item associated with the at least one second application based on at least one of applications frequently used with the first application, frequently used with applications similar to the first application, user selected applications, and system defined applications based on their cross-functional similarities.
